(19) United States
(12) Patent Application Publication
(10) Pub. No.: US 2022/0210709 A1
(43) Pub. Date: Jun. 30, 2022

(54) METHOD AND APPARATUS FOR INITIATING HANDOVER (HO) PROCEDURE IN AN OPEN-RADIO ACCESS NETWORK (O-RAN) ENVIRONMENT

(71) Applicant: Sterlite Technologies Limited, Gurgaon (IN)

(72) Inventors: Shyam Parekh, Orinda, CA (US); Kevin Tang, Dublin, CA (US); Ravishankar Ravindran, San Ramon, CA (US)

(21) Appl. No.: 17/139,429

(22) Filed: Dec. 31, 2020

(51) Int. Cl. H04W 36/08; H04W 36/00

(52) U.S. Cl. CPC H04W 36/08; H04W 36/0085; H04W 36/0061

(57) ABSTRACT

A method and apparatus for initiating a handover (HO) procedure in an open-Radio Access Network (O-RAN) environment is disclosed. Particularly, a method for identifying a target cell for handover by a RAN controller in the O-RAN environment is disclosed. The O-RAN environment has a virtualized network architecture comprising the RAN controller is connected to an E2 node, the RAN controller is connected via the E2 node to a plurality of user equipments (UEs) positioned in a serving cell, a cell covering a location for serving a UE, the serving cell is adjacent to a plurality of neighbour cells. The method includes obtaining signal strength metrics and corresponding resource load metrics of each neighbour cell from a plurality of neighbour cells; comparing a plurality of cell parameters of the plurality of neighbour cells among each other based on one or more predefined threshold values and identifying the target cell based on the comparison.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present disclosure relates to a wireless communication system, and more specifically relates to a method and apparatus for initiating a handover (HO) procedure in an open-Radio Access Network (O-RAN) environment.

### Description of the Related Art

As a location of a user equipment (UE) is moved from a service area defined by “X” cell into that defined by “Y” cell, the UE must disconnect with “X” base station and connect with “Y” base station (i.e., establish a new connection). This operation is sometimes known as handover (HO) or a cell reselection.

One important operation while performing the HO, for example, is that the UE requires to monitor signalling strength values of “Y” cells that is neighbour to the “X” cell to which the UE is connected thereto, (i.e., “serving cell”). More particularly, the HO operation involves comparing the monitored signalling strength values of the neighbour cells (the “Y” cells) with a signalling strength value of the serving cell (the “X” cell). In case, if the signalling strength value of the neighbour cell is considered by the UE to be stronger than that of the serving cell, the UE initiates the HO to the neighbour cell, which becomes the new serving cell.

A sole requisite of performing the HO based on relative signal strength values may not be sufficient for performing the inter-RAT (radio access technology) or intra-RAT HO. For example, it may be possible for a UE to be handed over to a cell where the higher cell loading could result in a poor performance for the UE.

Hence, even when the target cell may provide improved signal strength values for the UE following the HO, overall performance at the target cell may not be ideal. Therefore, failing to achieve load balancing across different cells in 4G/LTE and 5G networks with optimal UE performance.

Accordingly, the present invention seeks to ameliorate one or more of the aforementioned disadvantages or provide a useful alternative.

### BRIEF SUMMARY OF THE INVENTION

The principal objective of the present invention is to provide an efficient handover (HO) mechanism of a user equipment (UE) to a neighbour cell that ensures optimum usage of resources within a radio access network.

Another objective of the present invention is to identify the best target cell for handover by comparing received signal power and average load values for each candidate cell and sorting the data to identify best target cell for handover with best combination of high RSRP (reference signal received power) and low average load.

Another objective of the present invention is to perform sorting of candidate cells according to RSRP/RSRQ (reference signal received quality) values and PRB utilization values.

Another objective of the present invention is to determine a best candidate target cell for handover (by identifying correct combination for RSRP and average load values for the cell). Further protecting against identifying a target cell with higher average load and lower received signal strength.

Another objective of the present invention is to achieve load balancing across different cells in 4G/LTE and 5G networks, even after the HO operation.

Accordingly, herein discloses a method for initiating a handover (HO) procedure in an open-Radio Access Network (O-RAN) environment. More particularly, a method for identifying a target cell for handover by a Radio access network (RAN) controller in an open RAN (O-RAN) environment, the O-RAN environment has a virtualized network architecture comprising the RAN controller, the RAN controller is able to control, via an E2 node, a plurality of user equipment's (UE's) positioned in a serving cell, a cell covering a location for serving a UE, the serving cell is adjacent to a plurality of neighbour cells. The method comprising comparing a plurality of cell parameters of the plurality of neighbour cells among each other based on one or more predefined threshold values and identifying the target cell for handover based on the comparison.

The method further includes obtaining the plurality of cell parameters from a radio network information base (RNIB) wherein the cell parameters are associated with the serving cell and each of neighbour cells from the plurality of neighbour cells. The plurality of cell parameters comprises received signal strength parameters and average load parameters.

The signal strength parameters comprise reference signal received power (RSRP)/reference signal received quality (RSRQ) and wherein the average load parameters comprise physical resource blocks (PRB) utilizations.

The comparison of the plurality of cell parameters includes sorting the plurality of neighbour cells based on the plurality of cell parameters.

The comparison of the plurality of cell parameters further includes filtering the plurality of neighbour cells for which the one or more received signal strength parameters of the neighbour cells is greater than one or more predefined thresholds and sorting the filtered plurality of neighbour cells in descending order of the received signal strength parameters in response to determining that the received signal strength parameters of the plurality neighbour cells is greater than one or more predefined thresholds. The one or more predefined thresholds comprising reference signal received power (RSRP) threshold value, reference signal received quality (RSRQ) threshold value and physical resource blocks (PRB) utilization threshold values.

The method further includes selecting the target cell from the sorted plurality of neighbour cells, and wherein the target cell comprises highest received signal strength parameters among the plurality of received signal strength parameters of the neighbour cells while attempting to ensure that the target cell is not congested.

The comparison of the plurality of cell parameters further includes sorting the plurality of neighbour cells based on the cell parameters, wherein the cell parameters used for sorting are received signal strength parameters and load parameters for each of the plurality of candidate cells.

The method further includes selecting the target cell from the sorted plurality of neighbour cells and wherein the target cell comprises highest value of the received signal strength parameter, along with average load values of the neighbour cells below the predefined average load thresholds.

The method further includes transmitting information of the identified target cell to the UE for handover, where the information has at least one of data corresponding to identified target cell.

Accordingly, herein discloses a Radio access network (RAN) controller for initiating a handover (HO) procedure in an open-Radio Access Network (O-RAN) environment. More particularly, the RAN controller for identifying a target cell for handover by a Radio access network (RAN) controller in an open RAN (O-RAN) environment, the O-RAN environment has a virtualized network architecture comprising the RAN controller, the RAN controller is able to control, via an E2 node, a plurality of user equipment's (UE's) positioned in a serving cell, a cell covering a location for serving a UE, the serving cell is adjacent to a plurality of neighbour cells. The RAN controller configured to compare a plurality of cell parameters of the plurality of neighbour cells among each other based on one or more predefined threshold values and identify the target cell based on the comparison.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modification.

### DESCRIPTION OF THE DRAWINGS

In order to best describe the manner in which the above-described embodiments are implemented, as well as define other advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings in which:

FIG. 1 illustrates a wireless communication system;

FIG. 2 illustrates overview of an Open-Radio Access Network (O-RAN) architecture;

FIG. 3 illustrates various hardware elements in a RAN;

FIG. 4 illustrates various hardware elements in a RAN controller;

FIG. 5 is a flow chart illustrating a method for selecting a candidate cell. The operations are performed by the RAN controller.

It should be noted that the accompanying figures are intended to present illustrations of few exemplary embodiments of the present disclosure. These figures are not intended to limit the scope of the present disclosure. It should also be noted that accompanying figures are not necessarily drawn to scale.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

### Standard Networking Terms and Abbreviation

RAN: A RAN may stand for radio access network. A radio access network (RAN) may be a part of a telecommunications system which may connect individual devices to other parts of a network through radio connections. A RAN may provide a connection of user equipment such as mobile phone or computer with the core network of the telecommunication systems. A RAN may be an essential part of access layer in the telecommunication systems which utilize base stations (such as e node B, g node B) for establishing radio connections.

Wireless communication system: A wireless communication system may consist of various network components connected via wireless networks. The wireless networks may comprise of any wireless connectivity technology such as radio links, millimeter wave, etc. In this document, the wireless communication system may include one or more controller connected with radio access networks, which are further connected with a plurality of user equipments.

New RAN: A Radio Access Network which can support either NR/E-UTRA or both and have capabilities to interface with Next Generation Core Network (NG-CN). NG-C/U is a Control/User Plane interface towards NG-CN.

gNB: New Radio (NR) Base stations which have capability to interface with 5G Core named as NG-CN over NG-C/U (NG2/NG3) interface as well as 4G Core known as Evolved Packet Core (EPC) over S1-C/U interface.

LTE eNB: An LTE eNB is evolved eNodeB that can support connectivity to EPC as well as NG-CN.

Non-standalone NR: It is a 5G Network deployment configuration, where a gNB needs an LTE eNodeB as an anchor for control plane connectivity to 4G EPC or LTE eNB as anchor for control plane connectivity to NG-CN.

Standalone NR: It is a 5G Network deployment configuration where gNB does not need any assistance for connectivity to core Network, it can connect by its own to NG-CN over NG2 and NG3 interfaces.

Non-standalone E-UTRA: It is a 5G Network deployment configuration where the LTE eNB requires a gNB as anchor for control plane connectivity to NG-CN.

Standalone E-UTRA: It is a typical 4G network deployment where a 4G LTE eNB connects to EPC.

Xn Interface: It is a logical interface which interconnects the New RAN nodes i.e. it interconnects gNB to gNB and LTE eNB to gNB and vice versa.

As per the O-RAN Alliance (O-RAN-WG1 OAM Architecture-v02.00), “the near real time RAN Intelligent Controller (near RT RIC) is a logical function that enables near-real-time control and optimization of O-RAN elements and resources via fine-grained data collection and actions over E2 interface. The Non-Real Time Radio Intelligent Controller (non RT RIC) is a logical function that enables non-real-time control and optimization of RAN elements and resources, AI/ML workflow including model training and updates, and policy based guidance of applications/features in near-RT RIC. It is a part of the Service Management & Orchestration Framework and communicates to the near-RT RIC using the A1 interface. Non-RT control functionality (>1s) and near-Real Time (near-RT) control functions (<1s) are decoupled in the RIC. Non-RT functions include service and policy management, RAN analytics and model-training for some of the near-RT RIC functionality, and non-RT RIC optimization. O-CU is O-RAN Central Unit, which is a logical node hosting RRC, SDAP and PDCP protocols. O-CU-CP is O-RAN Central Unit-Control Plane, which is a logical node hosting the RRC and the control plane part of the PDCP protocol. The O-CU-UP is O-RAN Central Unit-User Plane, which is a logical node hosting the user plane part of the PDCP protocol and the SDAP protocol. The O-DU is O-RAN Distributed Unit, which is a logical node hosting RLC/MAC/High-PHY layers based on a lower layer functional split. The O-RU is O-RAN Radio Unit, which is a logical node hosting Low-PHY layer and RF processing based on a lower layer functional split. This is similar to 3GPP's “TRP” or “RRH” but more specific in including the Low-PHY layer (FFT/iFFT, PRACH extraction). The O1 interface is an interface between management entities in Service Management and Orchestration Framework and O-RAN managed elements, for operation and management, by which FCAPS management, Software management, File management shall be achieved. The xAPP is an independent software plug-in to the Near-RT RIC platform to provide functional extensibility to the RAN by third parties.” The near-RT RIC controller can be provided different functionalities by using programmable modules as xAPPs, from different operators and vendors.

The A1 interface may be defined as an interface between non-RT RIC and Near-RT RIC to enable policy-driven guidance of Near-RT RIC applications/functions, and support AI/ML workflow. The data packets which are communicated over the AI interface may be called A1 messages. The E2 interface may be defined as an interface connecting the Near-RT RIC and one or more O-CU-CPs, one or more O-CU-UPs, and one or more O-DUs. The data packets which are communicated over E2 interface may be called E2 messages.

In the following detailed description of embodiments of the invention, numerous specific details are set forth in order to provide a thorough understanding of the embodiment of invention. However, it will be obvious to a person skilled in the art that the embodiments of the invention may be practiced with or without these specific details. In other instances, well known methods, procedures and components have not been described in details so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the scope of the invention.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

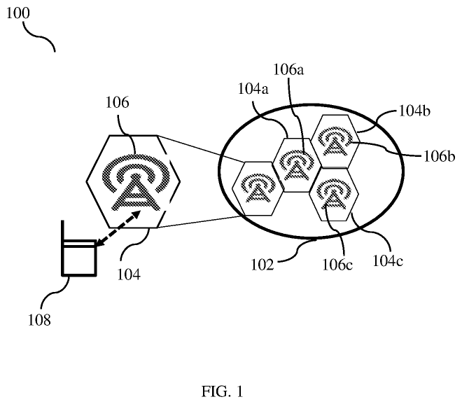

Referring now to the drawings, and more particularly to FIGS. 1 through 5, there are shown preferred embodiments.

Referring to FIG. 1, a wireless communication system comprising a mobile communication service area/system (102), such as LTE/4G or 5G system service area is shown. In an example, the mobile communication service area (102) may be a service area shared by the both 4G and 5G systems or may be associated with an independent radio access technology (RAT) 4G/5G system. The mobile communication service area (102) may include a number of cells (104, 104a, 104b, 104c . . . 104n). In the mobile communication service area (102), the UE (108) may be located in a cell (104) (i.e., a serving cell) that may be served by a base station (106) (i.e., serving base station). In some example, each of cell (104a, 104b, 104c . . . 104n) i.e., neighbor to the serving cell (104) comprises a respective base station (106a, 106b, 106c . . . 106n) that may be referred to as the neighbor base stations. The base stations (106, 106a, 106b, 106c . . . 106n) in the mobile communication system (102) can be configured to route communication data of the UE (108) and other equipment through the mobile communication system (102). The base stations (106, 106a, 106b, 106c . . . 106n) may communicate control information and/or user data with a core network through backhaul. The wireless communication system (100) may support operation on multiple carriers. For example, each communication link may be a multi-carrier signal modulated according to various radio technologies. Each modulated signal may be sent on a different carrier and may carry control information (e.g., reference signals, control channels, etc.), overhead information, data, etc.

The base stations (106, 106a, 106b, 106c . . . 106n) may wirelessly communicate with the UE (108) via one or more base station antennas. Each of the base stations (106, 106a, 106b, 106c . . . 106n) may provide communication coverage for a respective coverage area. For example, the base stations (106, 106a, 106b, 106c . . . 106n) may be referred to as a Radio Base Station (RBS), evolved Node B (“eNB”), “eNodeB”, “NodeB”, “B node”, gNB, or Base Transceiver Station (BTS), depending on the technology and terminology used.

The UE (108) may be a wireless device e.g., mobile terminal, wireless terminal, terminal, and/or Mobile Station (MS). The wireless device may be, for example, portable, hand-held, computer-comprised, or vehicle-mounted mobile devices, enabled to communicate voice and/or data, via the network node, with another entity, such as another terminal or a server. The UE (108) is enabled to communicate wirelessly in a cellular communication network or wireless communication network.

In some example in context of the handover when a signal strength of the serving base station (106) deteriorate with respect to its communication with the UE (108) and as detailed in the background section i.e., a handover event is triggered from the serving cell (104) (comprising the serving base station (106) to at least one neighbour cell (104a or 104b or 104c . . . 104n) comprising a target base station (106a or 106b or 106c . . . 106n).

In some examples, the UE (108) may send periodic or event-based measurement reports to the serving base station (106). Further, a handover process may be initiated based on the transmission of the measurement report from the UE (108) to the serving base station (106). In response to receiving the measurement reports at the serving base station (106), the base station may decide whether to trigger a handover and if so, decide to which target base station (106a or 106b or 106c . . . 106n) the UE (108) should be handed over. In addition to the measurement reports, other criteria may also be considered by the serving base station (106) before a control message is sent to the target base station (106a or 106b or 106c . . . 106n) to prepare for the handover.

As detailed above (background section), conventional methods of facilitating a handover have focused solely on initiating the handover process based on the downlink measurement reports including Reference Signal Received Power (RSRP) and/or Reference Signal Received Quality (RSRQ). Such conventional method may not be optimal due to dynamic variation in the RSRP/RSRQ measurements and further with respect to non-consideration of the load balancing among the cells during the handover. However, in accordance with the present disclosure, a best target cell is identified by sorting the plurality of neighbour cells (104a, 104b, 104c . . . 104n) based on the plurality of cell parameters. The present invention aims at performing the sorting of candidate cells according to RSRP/RSRQ values and PRB utilization values. As per 3GPP ETSI TS 136 214 V9.1.0 (2010-04) technical specification, the RSRP may be defined as “Reference signal received power (RSRP), is defined as the linear average over the power contributions (in [W]) of the resource elements that carry cell-specific reference signals within the considered measurement frequency bandwidth.” RSRP may be the power of the LTE Reference Signals spread over the full bandwidth and narrowband.

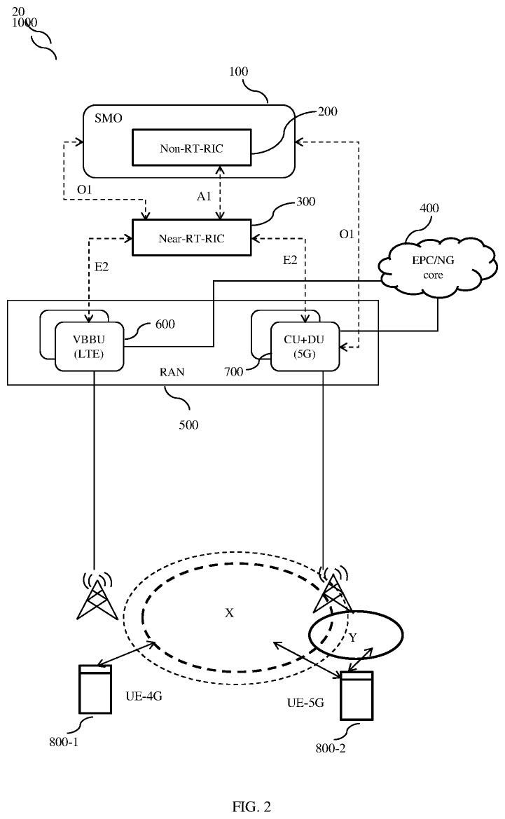

Referring to FIG. 2 in conjunction with FIG. 1, an Open-Radio Access Network (O-RAN) architecture (200) includes a Service Management and Orchestration (SMO) framework (202) and a radio access network (RAN) intelligent controller (RIC) (210) connected to a radio access network (RAN) (208). The SMO (202) is configured to provide SMO functions/services such as data collection and provisioning services of the RAN (208). The O-RAN is an evolved version of prior radio access networks, makes the prior radio access networks more open and smarter than previous generations. The O-RAN provides real-time analytics that drive embedded machine learning systems and artificial intelligence back end modules to empower network intelligence. Further, the O-RAN includes virtualized network elements with open and standardized interfaces. The open interfaces are essential to enable smaller vendors and operators to quickly introduce their own services, or enables operators to customize the network to suit their own unique needs. Open interfaces also enable multivendor deployments, enabling a more competitive and vibrant supplier ecosystem. Similarly, open source software and hardware reference designs enable faster, more democratic and permission-less innovation. Further, the O-RAN introduces a self-driving network by utilizing new learning based technologies to automate operational network functions. These learning based technologies make the O-RAN intelligent. Embedded intelligence, applied at both component and network levels, enables dynamic local radio resource allocation and optimizes network wide efficiency. In combination with O-RAN's open interfaces, AI-optimized closed-loop automation is a new era for network operations.

The SMO (202) is configured to provide SMO functions/services such as data collection and provisioning services of the RAN (208). As per O-RAN Alliance (O-RAN-WG1 OAM Architecture-v02.00), the SMO can be defined as “Service Management and Orchestration Framework is responsible for the management and orchestration of the managed elements under its span of control. The framework can for example be a third-party Network Management System (NMS) or orchestration platform. Service Management and Orchestration Framework must provide an integration fabric and data services for the managed functions. The integration fabric enables interoperation and communication between managed functions within the O-RAN domain. Data services provide efficient data collection, storage and movement capabilities for the managed functions. In order to implement multiple OAM architecture options together with RAN service modeling, the modeling of different OAM deployment options and OAM services (integration fabric etc.) must be supported by SMO”. The RAN (208), herein, is implemented in the O-RAN computing architecture (200). The RAN (208) may implement a single radio access technology (RAT) (4G/5G) or multiple RATs (4G and 5G) using the base stations (106, 106a, 106b, 106c . . . 106n) located in the wireless communication network (100). The data collection of the SMO framework (202) may include, for example, data related to a bandwidth of the wireless communication network (100) and the UE (108).

The base stations (106, 106a, 106b, 106c . . . 106n) may be for e.g. a Radio Base Station (RBS), also referred to as e.g., evolved Node B (“eNB”), “eNodeB”, “NodeB”, “B node”, gNB, or BTS (Base Transceiver Station), depending on the technology and terminology used. In some example, the base stations (106, 106a, 106b, 106c . . . 106n) may be a logical node that handles transmission and reception of signals associated with the plurality of cells. The base station (106) may connect to each other i.e., with the neighbour base stations (106a, 106b, 106c . . . 106n) via “Xn” interface either in a same network or to a network node of another network (intra-network). Each base station (106, 106a, 106b, 106c . . . 106n) may connect to one or more antennas. The base stations (106, 106a, 106b, 106c . . . 106n) may further communicate with the core network (not shown) comprising an evolved packet core (EPC) using an “S1” interface. More particularly, the base stations (106, 106a, 106b, 106c . . . 106n) may communicate with a Mobility Management Entity (MME) and a User plane entity (UPE) identified as Serving Gateway (S-GW) using S1-C and S1-U for control plane and user plane, respectively. In another aspect, the core network may be a 5G core network.

Referring back to FIG. 2, the RIC (210) can be a non-real-time-radio intelligent controller (Non-RT-RIC) (204) and a near-real-time-radio intelligent controller (Near-RT-RIC) (206). The Non-RT-RIC (204) may be configured to support intelligent RAN optimization in non-real-time. Further, the Non-RT-RIC (204) can be configured to leverage the SMO services and may be a part of the SMO (202). One such advantage of configuring the RAN (208) within the O-RAN computing environment and/or O-RAN architecture (200) is leveraging the intellectualization (“Artificial intelligence (AI)/Machine Learning (ML)) of the Non-RT-RIC (204) and the Near-RT-RIC (206).

The Near-RT-RIC (206) may host plurality of xApps, for example, target cell selection-xApp that is configured to select a best candidate cell i.e., target cell, from a plurality of candidate cells for performing the handover. The xApps (at the Near-RT-RIC (206)) uses an “E2” interface to collect near real-time RAN (208) information and to provide value added services using these primitives, guided by the policies/configuration and the enrichment data provided by the “A1” interface from the rApps at the Non-RT-RIC (204). An “O1” interface collects data for training in the Non-RT RIC (204) (integrated with SMO (202). The Apps at the Non-RT-RIC (204) may be called RApps.

In one example, the “E2” and “A1” interfaces may be used to exchange control messages, subscription messages, real-time measurements, policy trigger messages, indication messages, machine learning (ML) management and enrichment information types of messages, and the like. The real-time measurements comprising RSRP/RSRQ measurements, channel quality measurements and the like. The subscription messages such as, for example, limited-time RSRP/RSRQ subscription messages, limited-time A3 event subscription messages, and the like. The policy trigger messages, for example, include spectrum allocation policies, radio assignment policies, and the like.

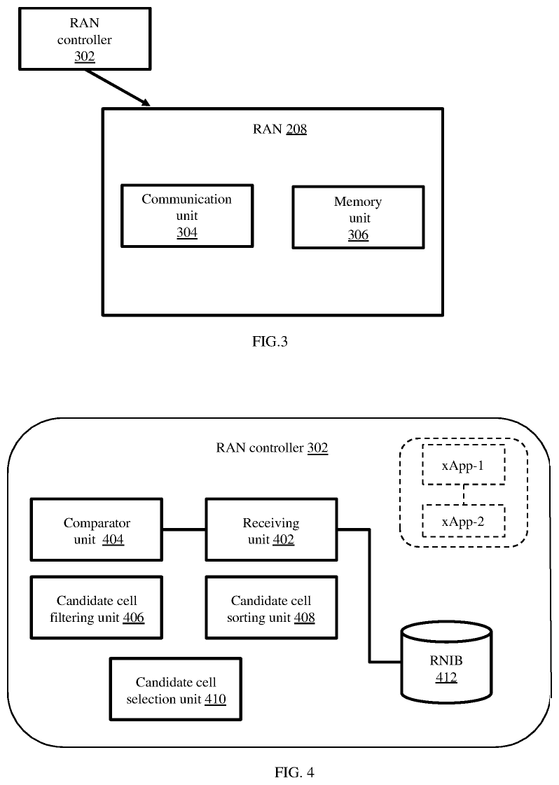

Referring to FIG. 3, in conjunction with FIG. 2, the RAN (208) may be connected to RAN controller (302). The RAN (208) may be include a communication unit (304), and a memory unit (306). In some example, the RAN controller (302) may be implemented as one or more processors, microprocessors, microcomputers, microcontrollers, digital signal processors, central processing units, state machines, logic circuitries, and/or any devices that manipulate signals based on operational instructions. In some example, the RAN controller (302) may reside outside the RAN (208). In some example, the the RAN controller (302) may control a plurality of RANs such as RAN (208). In some example, the RAN (208) may include the RAN controller (302). Among other capabilities, the RAN controller (302) may be configured to fetch and execute computer-readable instructions stored in the memory unit (306). In some other example, the RAN controller (302) may be implemented by the RIC (210) i.e., xApps at the Near-RT-RIC (206) or xApps at the Non-RT-RIC (204).

The communication unit (304) may include interface(s) that is variety of software and hardware interfaces, for example, a web interface, a Graphical User Interface (GUI), a Command Line Interface (CLI) and the like. For example, interface(s) such as (“E2”, “O1”, “X2”, “S1” and the like). The communication unit (304) may be used for configuring the base station (106).

The memory unit (306) may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

The base station (106) that serves as a source base station (BS) may be referred as the serving base station (106) and the base stations (106a, 106b, 106c . . . 106n) that may serve as candidate base stations for the selection of the target base station (for e.g., 106a) may be referred as target BS (106a). The handover request may occur, for example, when there is a quality of the communication between the UE (108) and the serving BS (106) falls below threshold, set by the corresponding network operator. The weak communication may be, for example, due to variations in channel quality, signal strengths, or the like, which causes the UE (108) leaving the serving cell (104) that is served by the serving BS (106) and entering in to a new cell (i.e., for e.g., 104a or 104b or 104c).

In one example, the handover may be controlled by the serving BS (106). In some example, the handover may be controlled by the E2 node, for example, eNodeB and gNodeB. If the UE (108) initiates the handover, a UE-assisted handover may be performed. If the serving BS (106) initiates the handover, a network-controlled handover may be performed. The E2 node may be an O-RAN node which is part of RAN and may be connected to the near-RT-RIC via an E2 interface. The E2 node may include a centralized unit (CU), a distributed unit (DU) and a radio unit (RU). The E2 nodes may connect with a plurality of UEs at one end and the near-RT-RIC at other end. The serving BS (106) may be the base station which is currently serving the UE. In another example, the serving BS may be the E2 node currently serving the UE.

The network-controlled handover, may be described below in conjunction with the present invention to achieve a desired technical effect of improved HO mechanism.

The following description will use the nomenclature used, a mobile telephone (108) that changes the serving cell (104) will be referred to as the UE (108), the network BS (106) that serves as a source may be referred as serving node/eNodeB/gNB and nodes/eNodesB/gNBs. The eNodeB/gNB (106a), eNodeB/gNB (106b) and eNodeB/gNB (106c . . . 106n) that may serve as candidate nodes for a target/neighbour cells (104a-c) may be referred as target node/eNodeB/gNB/BS. The terms “network node”, “serving node”, “serving network node”, “serving BS” and “serving eNB” may interchangeably be used. The terms “neighbour cells” and “a plurality of neighbour cells” may interchangeably be used.

Referring to FIG. 4, the RAN controller (302) comprises, for example, a receiving unit (402), a comparator unit (404), a candidate cell filtering unit (406), a candidate cell sorting unit (408), a candidate cell selection unit (410), and a radio network information base (RNIB) (412).

The components of the RAN controller (302) may be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

In some example, the receiving unit (402) can be configured to receive various types of data and control plane information from the wireless communication system (100) described with reference to FIG. 1. The receiving unit (402) may receive information such as measurements for data, and/or control information for the RAN (208). The received information may be utilized by the RAN controller (302) to make a determination as to whether to trigger the handover process from the serving base station (106) to the target base station (106a).

In some example, the receiving unit (402) may be configured to obtain a received signal strength value and a load value associated with the serving cell (104) and each of the neighbour cells from the plurality of neighbour cells (104a or 104b or 104c . . . 104n). In some example, the signal strength value includes RSRP and/or RSRQ and the load values include the PRB utilization values. In one example, the RSRP and/or RSRQ and the PRB utilization may be obtained from the RNIB (412). The RNIB (412) may be a storage unit configured to store the obtained measurement reports including the RSRP and/or RSRQ and further to store the obtained PRB utilization values. In some example, the PRB utilization values may be the radio resources utilized by a cell. The radio resource utilized by the cell may tell how much load is present in the cell. The PRB utilization values may signify the load parameters within the cell. In another example, the RNIB (412) may be located within the RAN controller (302) and/or the base station (106) or may be remotely located to the RAN controller (302) and/or the base station (106). The receiving unit (402) may be configured to transmit the obtained RSRP and/or RSRQ and the PRB values to the comparator unit (404).

In some example, the comparator unit (404) can be configured to compare the plurality of cell parameters of the plurality of neighbour cells (104a or 104b or 104c . . . 104n) among each other based on one or more predefined threshold values. The plurality of cell parameters comprises, for example, the RSRP and/or RSRQ and the PRB utilization values.

In some example, the comparator unit (404) may be communicatively coupled to the candidate cell filtering unit (406) that can be configured to filter the plurality of neighbour cells (104a or 104b or 104c . . . 104n) for which the one or more received signal strength parameters of the neighbour cells (104a or 104b or 104c . . . 104n) is greater than one or more predefined thresholds.

In some example, the comparator unit (404) and the candidate cell filtering unit (406) may be communicatively coupled to the candidate cell sorting unit (408) that can be configured to sort the filtered plurality of neighbour cells (104a or 104b or 104c . . . 104n) in descending order of the received signal strength parameters in response to determining that the received signal strength parameters of the plurality neighbour cells is greater than one or more predefined thresholds. The one or more predefined thresholds comprising RSRP value, RSRQ value and PRB utilization value.

In some example, the sorted plurality of neighbour cells (104a or 104b or 104c . . . 104n) are then utilized by the candidate cell selection unit (410) that is configured to select the target cell (e.g., 104a) from the sorted plurality of neighbour cells (104a or 104b or 104c . . . 104n). The target cell (104a) comprises the highest received signal strength parameters (RSRP and/or RSRQ) among the plurality of received signal strength parameters of the neighbour cells (104b or 104c . . . 104n).

In some example, the target cell (104a) may also comprise a comparatively lower average load values compared to average load values of other neighbour cells (104b or 104c . . . 104n).

In some example, the RAN controller (302) can be configured to transmit the information of the identified target cell (104a) to the UE (108) for handover, where the information has at least one of data corresponding to identified target cell (104a), and a list of candidate cells (104b or 104c . . . 104n) in descending order of preference i.e., RSRP/RSRQ values.

For example, according to conventional mechanism, the UE (108) may be configured to transmit measurement reports (MRs) upon receiving a measurement control metrics (as a radio resource control (RRC) connection reconfiguration) from the serving node (106). The serving node (106) may detect the neighbour cells (104a-c) operating in the mobile communication service area (102) from the MRs transmitted by the UE (108). The neighbour cells (104a-c), herein, are referred as the candidate cells for selection of the target cells. The serving node (106) may configure the measurements from the UE (108) according to the RRC connection reconfiguration based on the specified measurement configurations such as frequency, inter-RAT capabilities and others. Further, the UE (108) may evaluate whether or not the neighbour cells (104a-c) meet the one or more pre-defined conditions, which are currently known in the art (for example, the UE (108) may check if any of the neighbour cells (104a-c) is barred or not barred, etc.).

After evaluating the one or more conditions, the UE (108) may send a measurement report (MR), to the serving node (106) based on pre-defined rules. The pre-defined rules may be set by the measurement configuration message sent by the serving cell (104). In order to send MR, the UE (108) may have to measure signal strength power and/or quality of the neighbour cells (104a-c). For example, the UE (108) measures the signal strength parameters on reference signal i.e., RSRP and/or RSRQ.

Generally, after receiving the Measurement Reports (MRs), the serving node (106) may be configured to send the handover request to the target BS (106a) of the neighbour cell (104a) having the highest RSRP values and handover is performed. For example, referring to Table. 1, the serving node (106), at first, may evaluate each neighbour cell IDs to identify which neighbour cell ID has the highest RSRP value. Further, at step two, the serving node (106) may send the handover request to the neighbour cell (104a) with a physical cell ID-1 having the highest RSRP value when compared to the RSRP value of the neighbour cell (104b) served by the candidate cell BS (106b) with a physical cell ID-2 and other neighbour cells (for example, 104c, served by the candidate cell BS (106c)) with a physical cell ID-3. The candidate cell BS (106b) may be the base station associated with the candidate cell. The candidate cell BS (106b) may be the E2 node associated with the candidate cell. The candidate cell may include all the cells neighbor to the serving cell, and may be used for identifying a target cell for handover of the UE from the serving cell to the target cell.

TABLE 1

| Neighbour cell ID | RSRP | Load values |
|---|---|---|
| Cell ID 2 | −95.12 | 0.6 |
| Cell ID 1 | −90.12 | 0.7 |
| Cell ID 3 | −91.89 | 0.5 |

Thus, the process of evaluating each neighbour cell IDs to determine the highest RSRP values may not be critical if the RSRP values do not differ significantly. Further, the candidate cell selection considering the RSRP values is independent of the load values of the neighbour cells (104a-c) in that, for example, if the load of the neighbour cell (104a) is high, then the HO of the UE (108) to the neighbour cell (104a) may result in poor performance for the UE (108). As referring to Table. 1, the average load value of the neighbour cell (104b) is lower than the neighbour cell (104a) and handover of the UE (108) to the neighbour cell (104a) may be not be justifiable only on account of the RSRP value which is higher by a relatively smaller value. Further, the neighbour cell (104a) which may serve the UE (108), post HO, may experience a scarcity in a radio resource assignment (i.e., spectrum shortage) allocated by the network operators and further impacting the Quality of Experience (QoE) and Quality of Service (QoS) of the wireless communication system and the UEs connected to the neighbour cell (104a).

Therefore, selecting the neighbour cell (104a) (i.e., candidate cell) solely based on the RSRP values may not be ideal for handover.

Unlike conventional mechanism in order to select the best candidate cell/network node, the present invention aims at comparing the cell utilization/cell load and RSRP/RSRQ values among all the neighbour cells (104a-c). Thereby, achieving load balancing across different cells in the 4G/LTE and 5G networks. Further, unlike conventional mechanism, the present invention provides a trade-off between the RSRP value and load values to provide the best candidate cell for HO. For example, referring to Table. 1, the neighbour cell ID-3 may be an optimal selection for the candidate cell in that the RSRP value is next to the best RSRP value in the Table.1 (i.e., RSRP of neighbour cell ID-1) along with a lowest cell load utilization or zero load utilization. Thus, the present disclosure aims at identifying the best target cell for handover by comparing RSRP and/or RSRQ and average PRB utilization values for each candidate cell and sorting the data to identify best target cell for handover with best combination of high RSRP and low average load.

Unlike to conventional HO procedure (localized to the serving node (106)), the present invention leverages the Near-RT-RIC (206) of the O-RAN architecture (200) to provide a centralized mechanism for initiating the handover procedure. The proposed method may automatically triggered whenever a new neighbour cell is detected or is added in the list of neighbour cells i.e., updated list. Further, the proposed method may be executed parallelly and simultaneously using all the neighbour cells. The proposed method may respond to an A3 event indicated by a UE.

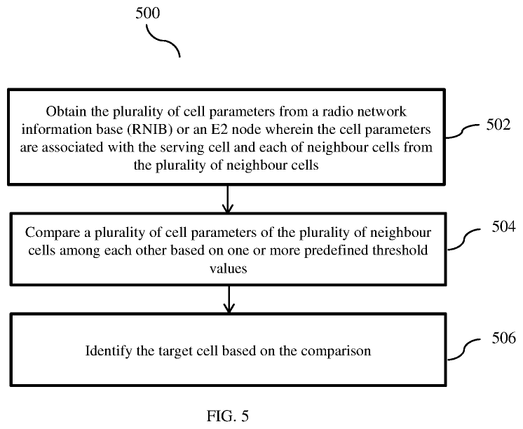

Referring to FIG. 5 that illustrates a flow chart (500) for identifying the target cell for handover in the open RAN (O-RAN) environment (200). The operations (502-506) are performed by the RAN controller (302).

At S502, the method includes obtaining the plurality of cell parameters from the RNIB (412), where the cell parameters are associated with the serving cell (104) and each of neighbour cells from the plurality of neighbour cells (104a, 104b or 104c . . . 104n).

At step S504, the method includes comparing the plurality of cell parameters of the plurality of neighbour cells (104b or 104c . . . 104n) among each other based on one or more predefined threshold values.

At step S506, the method includes identifying the target cell based on the comparison.

The various actions, acts, blocks, steps, or the like in the flow chart (500) may be performed in the order presented, in a different order or simultaneously. Further, in some embodiments, some of the actions, acts, blocks, steps, or the like may be omitted, added, modified, skipped, or the like without departing from the scope of the invention.

In one aspect of the invention, the method may identify a target cell having highest RSRP value with load value for handover of the UE from the serving cell to the target cell. The method may perform identifying the target cell from a list of candidate cells with highest RSRP value while continuously checking if load condition of the candidate cells is above a specified threshold value of average load threshold. The method may ensure that the identified target cell is useful for performing handover of the UE to the target cell.

The embodiments disclosed herein can be implemented using at least one software program running on at least one hardware device and performing network management functions to control the elements.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope of the invention. It is intended that the specification and examples be considered as exemplary, with the true scope of the invention being indicated by the claims.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware.

The results of the disclosed methods may be stored in any type of computer data repository, such as relational databases and flat file systems that use volatile and/or non-volatile memory (e.g., magnetic disk storage, optical storage, EEPROM and/or solid state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

Although the present disclosure has been explained in relation to its preferred embodiment(s) as mentioned above, it is to be understood that many other possible modifications and variations can be made without departing from the spirit and scope of the inventive aspects of the present invention. It is, therefore, contemplated that the appended claim or claims will cover such modifications and variations that fall within the true scope of the invention.

What is claimed is:

1. A method for identifying a target cell for handover by a Radio access network (RAN) controller in an open RAN (O-RAN) environment, the O-RAN environment has a virtualized network architecture comprising the RAN controller, the RAN controller is connected to an E2 node, the RAN controller is connected via the E2 node to a plurality of user equipments (UEs) positioned in a serving cell, a cell covering a location for serving a UE, the serving cell is adjacent to a plurality of neighbour cells, comprising:
comparing a plurality of cell parameters of the plurality of neighbour cells among each other based on one or more predefined threshold values; and
identifying the target cell based on the comparison.

2. The method as claimed in claim 1, comprising:
obtaining the plurality of cell parameters from atleast one of radio network information base (RNIB) and the E2 nodes, wherein the plurality of cell parameters is associated with the serving cell and each of neighbour cells from the plurality of neighbour cells.

3. The method as claimed in claim 1, wherein the plurality of cell parameters comprises received signal strength parameters and average load parameters.

4. The method as claimed in claim 1, wherein the signal strength parameters comprise reference signal received power (RSRP)/reference signal received quality (RSRQ) and wherein the average load parameters comprise physical resource blocks (PRB) utilization.

5. The method as claimed in claim 1, wherein comparison of the plurality of cell parameters comprises sorting the plurality of neighbour cells based on the plurality of cell parameters.

6. The method as claimed in claim 1, wherein the comparison of the plurality of cell parameters further comprises:
filtering the plurality of neighbour cells for which the one or more received signal strength parameters of the neighbour cells is greater than one or more predefined thresholds; and
sorting the filtered plurality of neighbour cells in descending order of the received signal strength parameters in response to determining that the received signal strength parameters of the plurality neighbour cells is greater than one or more predefined thresholds,
wherein the one or more predefined thresholds comprising reference signal received power (RSRP) threshold value, reference signal received quality (RSRQ) threshold value and physical resource blocks (PRB) utilization threshold value.

7. The method as claimed in claim 6, wherein the method further comprises selecting the target cell from the sorted plurality of neighbour cells, and wherein the target cell comprises highest received signal strength parameters among the plurality of received signal strength parameters of the neighbour cells.

8. The method as claimed in claim 1, wherein comparison of the plurality of cell parameters further comprising sorting the plurality of neighbour cells based on the cell parameters, wherein the cell parameters used for sorting are received signal strength parameters and load parameters for each of the plurality of candidate cells.

9. The method as claimed in claim 8, wherein the method further comprises selecting the target cell from the sorted plurality of neighbour cells and wherein the target cell comprises highest value of the received signal strength parameter and lowest average load values of the neighbour cells.

10. The method as claimed in claim 1, further comprising:
transmitting information of the identified target cell to the serving BS for handover, wherein the information has at least one of data corresponding to identified target cell, and a list of candidate cells in descending order of preference.

11. A Radio access network (RAN) controller for identifying a target cell for handover by a Radio access network (RAN) controller in an open RAN (O-RAN) environment, the O-RAN environment has a virtualized network architecture comprising the RAN controller, the RAN controller is connected to an E2 node, the RAN controller is connected via the E2 node to a plurality of user equipments (UEs) positioned in a serving cell, a cell covering a location for serving a UE, the serving cell is adjacent to a plurality of neighbour cells, the RAN controller configured to:
compare a plurality of cell parameters of the plurality of neighbour cells among each other based on one or more predefined threshold values; and
identify the target cell based on the comparison.

12. The RAN controller as claimed in claim 11, further configured to:
obtain the plurality of cell parameters from a radio network information base (RNIB), wherein the plurality of cell parameters is associated with the serving cell and each of neighbour cells from the plurality of neighbour cells.

13. The RAN controller as claimed in claim 11, wherein the plurality of cell parameters comprises received signal strength parameters and average load parameters.

14. The RAN controller as claimed in claim 11, wherein the signal strength parameters comprise reference signal received power (RSRP)/reference signal received quality (RSRQ) and wherein the average load parameters comprise physical resource blocks (PRB) utilization.

15. The RAN controller as claimed in claim 11, wherein comparison of the plurality of cell parameters comprises sorting the plurality of neighbour cells based on the plurality of cell parameters.

16. The RAN controller as claimed in claim 11, wherein the comparison of the plurality of cell parameters further comprises:
filtering the plurality of neighbour cells for which the one or more received signal strength parameters of the neighbour cells is greater than one or more predefined thresholds; and
sorting the filtered plurality of neighbour cells in descending order of the received signal strength parameters in response to determining that the received signal strength parameters of the plurality neighbour cells is greater than one or more predefined thresholds,
wherein the one or more predefined thresholds comprising reference signal received power (RSRP) value, reference signal received quality (RSRQ) value and physical resource blocks (PRB) utilization value.

17. The RAN controller as claimed in claim 16, wherein the RAN is further configured to select the target cell from the sorted plurality of neighbour cells and wherein the target cell comprises highest received signal strength parameters among the plurality of received signal strength parameters of the neighbour cells.

18. The RAN controller as claimed in claim 11, wherein RAN configured to compare the plurality of cell parameters further comprises sorting the plurality of neighbour cells based on the cell parameters, wherein the cell parameters used for sorting are received signal strength parameters and load parameters for each of the plurality of candidate cells.

19. The RAN controller as claimed in claim 18, wherein the RAN is further configured to select the target cell from the sorted plurality of neighbour cells and wherein the target cell comprises highest value of the received signal strength parameter and lowest average load values of the neighbour cells.

20. The RAN controller as claimed in claim 11, wherein the RAN is further configured to:
transmit information of the identified target cell to the serving BS for handover, wherein the information has at least one of data corresponding to identified target cell, and a list of candidate cells in descending order of preference.
